(19) United States
(12) Patent Application Publication
(10) Pub. No.: US 2008/0098294 A1
(43) Pub. Date: Apr. 24, 2008

(54) COLLABORATIVE ANNOTATION OF ELECTRONIC CONTENT

(75) Inventor: Tao Le, Elizabethtown, KY (US)

Correspondence Address: WOOD, HERRON & EVANS, LLP, 2700 CAREW TOWER, 441 VINE STREET, CINCINNATI, OH, 45202, US

(73) Assignee: MedIQ Learning, L.L.C., Elizabethtown, KY (US)

(21) Appl. No.: 11/551,763

(22) Filed: Oct. 23, 2006

(51) Int. Cl. G06F 17/00

(52) U.S. Cl. 715/230; 715/232

(57) ABSTRACT

An apparatus, program product and method provide a collaborative annotation environment that permits viewers of electronic content to share their personal annotations with other viewers of the electronic content only after the personal annotations have been reviewed by a party other than the original authors of such annotations. In addition, a default ordering may be generated for a plurality of annotations based upon the manner in which viewers of the annotations reorder the annotations. Furthermore, annotations that are submitted for review by multiple viewers may be scheduled for review according to the relative ratings of those viewers based upon prior submissions of those viewers.

### FIELD OF THE INVENTION

The invention relates to computers and computer software, and in particular, to the creation of annotations for electronic content.

### BACKGROUND OF THE INVENTION

Computers and computer technology have greatly improved the ability of individuals to access a wide variety of information in an innumerable number of areas. Furthermore, advances in computers and computer technology have made it much easier for individuals to comprehend and digest new information using new and innovative learning techniques.

As an example, computer technology has been widely applied in the educational arena to assist students with both class and test preparation. In the area of test preparation, for example, computer software has been developed both for administering tests or examinations to students, and to assist students in studying for tests or examinations. Computer-based study aids, for example, often present educational content in an indexed or outline form, and broken into a logical order, much in the same manner that content is presented in a non-electronic outline or topical summary. In many instances, students may also be tested on the material in specific sections of the educational content.

Computer-based study aids are in many respects conceptually similar to non-computer-based study aids that students have relied upon for decades. Students have long relied on outlines to pare down the content related to a particular subject into its most important facts and concepts to reduce the amount of information that needs to be memorized and understood. In some instances, students may choose to create their own outlines from their textbooks and class notes; however, in other instances, students may choose to purchase a published outline authored by an expert or group of experts in a particular subject. In many instances, the creation of the outline itself by the student assists the student in better comprehending the subject.

Another technique that students often rely upon to facilitate the learning process is annotation. Students routinely annotate textbooks with highlighting, underlining and margin notes. In addition, students often annotate commercially-published outlines, or even their own personal outlines, during test preparation.

Still further, some students rely on the work product of other students to assist them in their educational endeavors. Even discounting the cost savings, some students prefer used textbooks over new textbooks simply due to the annotations that have already been made in many used textbooks. In addition, students often trade outlines with other students, or obtain outlines from students who have taken a class in previous terms.

Computer-based educational products often provide a number of the benefits of the aforementioned learning techniques. For example, annotation functionality has been incorporated into a number of computer-based educational products, e.g., to enable viewers or readers of electronic content to make private or personal annotations such as highlights or notes that are displayed alongside the electronic content. In addition, some computer-based products permit users to share their annotations with friends and acquaintances.

Sharing personal annotations with other users, however, can be problematic, particularly for the other users who may view or read such annotations. In many instances the other users have no way of knowing whether the content of the shared annotations is factually correct. In addition, even if the content of such annotations is correct, the annotations may not be particularly useful to the other users. Annotations that may be useful to their authors may be confusing or unhelpful to other people who read the annotations. In addition, given that annotations are often authored quickly and without a great deal of concern for grammar, spelling, punctuation, etc., shared annotations may be difficult for others to comprehend if the original authors of the annotations do not take great care with the editorial content of their annotations.

As a result, in many conventional computer-based products that support the sharing of annotations, the quality of the annotations that a user may view is entirely dependent upon the actions of the original authors of such annotations. Consequently, should authors of annotations be careless, mistaken or even malicious, a risk exists that the shared annotations that they author will at best be useless to others, or at worst be misleading or counterproductive to the learning process.

Due to the increasingly prevalent nature of the Internet and computer-based educational tools, students have many more tools at their disposal for learning and comprehending many different types of subject matter. Furthermore, through the increased prevalence of collaboration and sharing tools, students are better able to interact with one another and assist one another in the learning process. Nonetheless, due to the effectively unmoderated nature of most conventional tools, students are often exposed to an inordinate amount of useless or counterproductive information.

Therefore, a significant need continues to exist in the art for a manner of enabling students and other viewers of electronic content to create their own annotations and view the annotations created by other viewers with a greater assurance that the annotations created by other viewers are helpful to their academic endeavors.

### SUMMARY OF THE INVENTION

The invention addresses these and other problems associated with the prior art by providing in one aspect an apparatus, program product and method that permit viewers of electronic content to share their personal annotations with other viewers of the electronic content only after the personal annotations have been reviewed by a party other than the original creators of such annotations. As such, viewers of the shared annotations have a greater assurance that the annotations that they are viewing are of at least some desired level of quality from a qualitative and/or editorial standpoint. Moreover, in many embodiments, the original personal annotations that viewers may submit for publication and/or sharing with other viewers may still be viewable by their original creators even if the annotations have been modified, rejected or have not yet been approved.

Therefore, consistent with one aspect of the invention, electronic content may be annotated by receiving from a first viewer of electronic content an annotation that has been created by the first viewer and that is associated with the electronic content, generating a display of the electronic content for the first viewer that includes the annotation along with the electronic content, and, based upon a review of the annotation by a party other than the first viewer, selectively enabling display of the annotation along with the electronic content to other viewers of the electronic content.

The invention addresses additional problems associated with the prior art by providing in another aspect an apparatus, program product and method that generate a default ordering of a plurality of annotations based upon the manner in which viewers of the annotations reorder the annotations. In particular, when multiple annotations are associated with electronic content, viewers of the electronic content may be permitted to rearrange the annotations based upon personal preference, often ordering annotations that are perceived as being of higher quality before those perceived as of being of lesser quality and/or ordering annotations that are logically related with one another in proximity to one another. By tracking the preferred orderings of the annotations by individual viewers, later viewers of the annotations may benefit from the efforts of the earlier viewers by being presented with the annotations in an order that is reflective of the preferences of the earlier viewers.

Therefore, consistent with this other aspect of the invention, electronic content may be displayed by generating, for each of a plurality of viewers of electronic content, a display associated with each such viewer that includes a plurality of annotations related to the electronic content, generating a default ordering for the plurality of annotations based at least in part upon how at least a subset of the plurality of viewers reorder the annotations in their associated displays, and generating a display associated with an additional viewer that includes the plurality of annotations ordered according to the generated default ordering.

The invention addresses additional problems associated with the prior art by providing in another aspect an apparatus, program product and method that schedule the review of annotations submitted by multiple viewers according to the relative ratings of those viewers. In particular, in an environment where a large number of viewers of electronic content choose to share their personal annotations, and where those annotations are required to be reviewed prior to their publication to other viewers, the volume of annotations awaiting review may become prohibitively large, resulting in inordinate delays before submitted annotations are approved for publication. However, in many instances, by rating viewers based upon their prior submissions, it may be possible to prioritize the submissions of viewers who have previously submitted worthwhile annotations over the submissions of viewers who have previously submitted worthless annotations or viewers for which no prior history is known, potentially enabling higher quality submissions to be approved more quickly.

Therefore, consistent with this other aspect of the invention, annotations associated with electronic content may be reviewed by receiving a plurality of annotations relating to electronic content submitted by a plurality of viewers of the electronic content, rating viewers based upon prior annotations submitted by such viewers, and scheduling reviews of the annotations by at least one editor based upon the rating of at least one viewer.

These and other advantages and features, which characterize the invention, are set forth in the claims annexed hereto and forming a further part hereof. However, for a better understanding of the invention, and of the advantages and objectives attained through its use, reference should be made to the Drawings, and to the accompanying descriptive matter, in which there is described exemplary embodiments of the invention.

### BRIEF DESCRIPTION OF THE DRAWINGS

FIG. 1 is a block diagram of a networked computer system incorporating collaborative content annotation consistent with the invention.

FIG. 2 is a flowchart illustrating an exemplary process for creating and displaying annotations using the computer system of FIG. 1.

FIG. 3 is a flowchart illustrating an exemplary process for reviewing annotations using the computer system of FIG. 1.

FIG. 4 is a flowchart illustrating an exemplary process for crediting viewers for submissions using the computer system of FIG. 1.

FIG. 5 is a flowchart illustrating an exemplary process for republishing content using the computer system of FIG. 1.

FIG. 6 is a block diagram illustrating an exemplary viewer display suitable for use in the computer system of FIG. 1.

FIG. 7 is a block diagram illustrating an exemplary editor display suitable for use in the computer system of FIG. 1.

### DETAILED DESCRIPTION

The embodiments discussed hereinafter provide a collaborative annotation environment that permits viewers of electronic content to create annotations and share those annotations with other viewers, with third party review utilized to provide editorial control over the annotations submitted by such viewers. Embodiments of the invention may be utilized to annotate practically any type of electronically-available content, e.g., educational material such as may be utilized in connection with test preparation. For example, in the embodiment discussed below, the electronic content constitutes test preparation materials for the United States Medical Licensing Examination (USMLE). However, it will be appreciated that the invention may be utilized in connection with other types of electronic content, including other types of test preparation materials, other types of educational materials, as well as various types of non-educational content.

In addition, a viewer of electronic content may be considered to include any individual capable of reading, viewing, listening, or otherwise accessing and consuming the electronic content. A viewer may also be permitted in many instances to create personal annotations and/or view public or shared annotations created by other viewers. An annotation may be considered to include any supplemental material, created or added by a viewer, that is in some manner associated with the electronic content.

An annotation may include textual information, and in some embodiments, may include other forms of information, e.g., audio information, graphical information, video information, animation, highlighting, underlining, etc. An annotation may include information that is generated by the viewer and/or information from another source that has been added by a viewer, e.g., through cutting and pasting from the other source. An annotation is typically personal with respect to a particular viewer when that viewer has created or authored the annotation, and such an annotation is typically considered private when that annotation is only accessible to the viewer that created the annotation. An annotation may be made public or shared when that annotation has been approved for viewing by viewers other than the viewer that created the annotation, and such approval may also be considered to be a form of publication.

An annotation may be associated with a specific portion of electronic content. For example, where electronic content is indexed into topics or other sections, an annotation may be associated with a specific topic or section. In the alternative, an annotation may simply be associated with the entire electronic content in some embodiments. In such embodiments, it may be desirable to permit viewers to organize annotations, e.g., into a tree of folders or based upon a table of contents or outline paradigm.

The approval or publication of an annotation is performed in the illustrated embodiments by a third party reviewer, e.g., an editor, who is typically an individual other than the individual who originally created or authored the annotation. In addition, as a result of a submitted annotation being approved for publication by a reviewer, the annotation becomes available for display to viewers other than the original creator of the annotation, including individuals other than the reviewer. The reviewer or editor may provide an editorial review of an annotation to check and/or edit the annotation for grammar, spelling, punctuation, etc. The reviewer or editor may also provide a qualitative review of the annotation to check for factual accuracy and overall suitability of the annotation for display along with the electronic content. The reviewer or editor may also be permitted to edit the annotation to correct mistakes or otherwise improve the usefulness or understandability of the annotation. It will be appreciated that either type of review may be performed without the other, and the both types of review may be performed by different reviewers. Furthermore, in some embodiments, any modifications to an annotation by a reviewer or editor may apply only to the published version of the annotation, leaving the original annotation in its unmodified state (and optionally displaying both the original and modified versions to the original author of the annotation, e.g., in separate personal and public annotation sections). In other embodiments, however, modifications made to an annotation by a reviewer or editor may be reflected back into the original, personal annotation. Furthermore, in some embodiments, a private or personal version of an annotation that has been published can later be modified or deleted by the original author of the annotation without affecting the published version of the annotation, i.e., the public and private versions of the annotation can each be separately edited, deleted, or otherwise modified after publication of the public version of the annotation.

A reviewer is often, but is not necessarily, an expert in the subject matter of the electronic content. In addition, a reviewer may be considered to also be a viewer of the electronic content, or may, due to being granted greater administrative and/or editorial rights, be considered to be a party who is separate from the primary viewers of the electronic content. Often, it is advantageous to utilize a third party reviewer who is in fact an expert in the relevant subject matter, particularly in embodiments where the electronic content is educational material in which viewers place great reliance on the fact that the annotations are factually correct.

An annotation, once created and/or published is typically displayed along with at least a portion of the electronic content, e.g., alongside a specific portion of the electronic content with which the annotation is contextually associated. The generation of a display incorporating both the electronic content and the annotation may be performed in a number of manners in different embodiments. For example, the generation of such a display may incorporate the population of a display region of a computer display with the electronic content and the annotation, e.g., where the annotation and electronic content are locally accessible by the computer where the display is presented to the viewer. In other instances, the generation of a display may incorporate the generation of data that is subsequently communicated to a different computer and processed by that computer to render a viewable representation of the electronic content and annotation. For example, in the illustrated embodiment, the electronic content is displayed in an Internet browser on a viewer's computer, whereby the browser processes web pages initially generated by a web server and transmitted to the viewer's computer over a computer network such as the Internet.

Other variations and modifications to the illustrated embodiments will be apparent to one of ordinary skill in the art having the benefit of the instant disclosure.

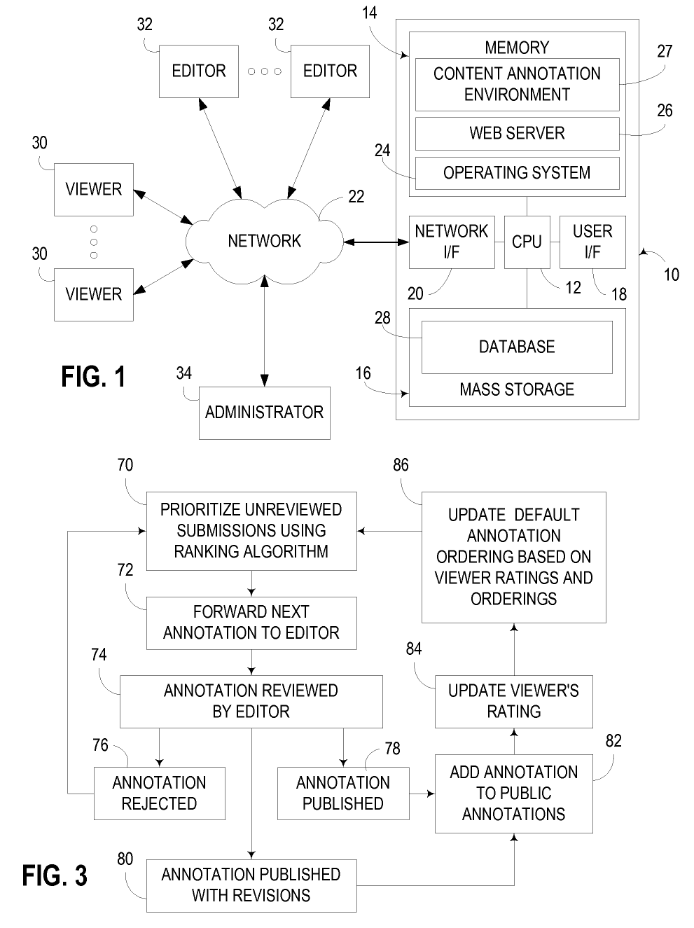

Turning now to the Drawings, wherein like numbers denote like parts throughout the several views, FIG. 1 illustrates an exemplary hardware and software environment for an apparatus 10 suitable for annotating electronic content in a manner consistent with the invention. For the purposes of the invention, apparatus 10 may represent practically any type of computer, computer system or other programmable electronic device, including a client computer, a server computer, a portable computer, a handheld computer, an embedded controller, etc. Moreover, apparatus 10 may be implemented using one or more networked computers, e.g., in a cluster or other distributed computing system. Apparatus 10 will hereinafter also be referred to as a “computer,” although it should be appreciated that the term “apparatus” may also include other suitable programmable electronic devices consistent with the invention.

Computer 10 typically includes a central processing unit (CPU) 12 including one or more microprocessors coupled to a memory 14, which may represent the random access memory (RAM) devices comprising the main storage of computer 10, as well as any supplemental levels of memory, e.g., cache memories, non-volatile or backup memories (e.g., programmable or flash memories), read-only memories, etc. In addition, memory 14 may be considered to include memory storage physically located elsewhere in computer 10, e.g., any cache memory in a processor in CPU 12, as well as any storage capacity used as a virtual memory, e.g., as stored on a mass storage device 16 or on another computer coupled to computer 10.

Computer 10 also typically receives a number of inputs and outputs for communicating information externally. For interface with a user or operator, computer 10 typically includes a user interface 18 incorporating one or more user input devices (e.g., a keyboard, a mouse, a trackball, a joystick, a touchpad, and/or a microphone, among others) and a display (e.g., a CRT monitor, an LCD display panel, and/or a speaker, among others). Otherwise, user input may be received via another computer or terminal, e.g., via a terminal or a client or single-user computer coupled to computer 10 over a network (e.g., administrator computer 34). This latter implementation may be desirable where computer 10 is implemented as a server or other form of multi-user computer. However, it should be appreciated that computer 10 may also be implemented as a standalone workstation, desktop, or other single-user computer in some embodiments.

For non-volatile storage, computer 10 typically includes one or more mass storage devices 16, e.g., a floppy or other removable disk drive, a hard disk drive, a direct access storage device (DASD), an optical drive (e.g., a CD drive, a DVD drive, etc.), and/or a tape drive, among others. Furthermore, computer 10 may also include an interface 20 with one or more networks 22 (e.g., a LAN, a WAN, a wireless network, and/or the Internet, among others) to permit the communication of information with other computers and electronic devices (e.g., one or more viewer computers 30, one or more editor computers 32 and one or more administrator computers 34). It should be appreciated that computer 10 typically includes suitable analog and/or digital interfaces between CPU 12 and each of components 14, 16, 18, and 20 as is well known in the art.

Computer 10 operates under the control of an operating system 24, and executes or otherwise relies upon various computer software applications, components, programs, objects, modules, data structures, etc. For example, a web server 26 and content annotation environment 27 may be resident in memory 14 to access a database 28 resident in mass storage 16. Moreover, various applications, components, programs, objects, modules, etc. may also execute on one or more processors in another computer coupled to computer 10 via a network, e.g., in a distributed or client-server computing environment, whereby the processing required to implement the functions of a computer program may be allocated to multiple computers over a network.

In general, the routines executed to implement the embodiments of the invention, whether implemented as part of an operating system or a specific application, component, program, object, module or sequence of instructions, or even a subset thereof, will be referred to herein as “computer program code,” or simply “program code.” Program code typically comprises one or more instructions that are resident at various times in various memory and storage devices in a computer, and that, when read and executed by one or more processors in a computer, cause that computer to perform the steps necessary to execute steps or elements embodying the various aspects of the invention. Moreover, while the invention has and hereinafter will be described in the context of fully functioning computers and computer systems, those skilled in the art will appreciate that the various embodiments of the invention are capable of being distributed as a program product in a variety of forms, and that the invention applies equally regardless of the particular type of computer readable signal bearing media used to actually carry out the distribution. Examples of computer readable signal bearing media include but are not limited to tangible, recordable type media such as volatile and non-volatile memory devices, floppy and other removable disks, hard disk drives, magnetic tape, optical disks (e.g., CD-ROMs, DVDs, etc.), among others, and transmission type media such as digital and analog communication links.

In addition, various program code described hereinafter may be identified based upon the application within which it is implemented in a specific embodiment of the invention. However, it should be appreciated that any particular program nomenclature that follows is used merely for convenience, and thus the invention should not be limited to use solely in any specific application identified and/or implied by such nomenclature. Furthermore, given the typically endless number of manners in which computer programs may be organized into routines, procedures, methods, modules, objects, and the like, as well as the various manners in which program functionality may be allocated among various software layers that are resident within a typical computer (e.g., operating systems, libraries, API's, applications, applets, etc.), it should be appreciated that the invention is not limited to the specific organization and allocation of program functionality described herein.

Those skilled in the art will recognize that the exemplary environment illustrated in FIG. 1 is not intended to limit the present invention. Indeed, those skilled in the art will recognize that other alternative hardware and/or software environments may be used without departing from the scope of the invention.

An exemplary implementation of the invention, utilized in connection with the display of test preparation materials to student viewers, is described in greater detail hereinafter. In this embodiment, the content annotation environment is incorporated into a test preparation application, where the electronic content includes test preparation materials regarding a test subject, e.g., test preparation materials for the USMLE. The electronic content is indexed into topics that are organized into sections and subsections, with individual topics being displayed to a viewer on one or more web pages, e.g., web pages incorporating multimedia content such as Flash-compatible content. The electronic content is initially resident on computer 10, e.g., in database 28, formatted into web pages by environment 27, and communicated to one or more viewer computers 30 by web server 26.

In addition, annotations are stored in database 28 and selectively incorporated into web pages by environment 27. Personal preferences for viewers are additionally stored in database 28 and used, for example, to store customization information such as the desired orderings of annotations on a web page, the hide/show status of annotations on a web page, the web pages visited by a viewer, and other information suitable for maintaining the progress of each viewer through the test preparation process.

In addition, as will become more apparent below, the web pages served to viewers may also include controls to permit viewers to submit their own personal annotations, as well as to request that such annotations be published such that they are displayed to other viewers. Each annotation stored in database 28 therefore includes an indication of the status of such annotation, e.g., private/public, awaiting review, approved, rejected, etc. Furthermore, to facilitate the review of submitted annotations for publication, environment 27 is capable of interacting with one or more reviewers/editors 32. Administration of environment 27 is typically managed via an administrator computer 34.

It will be appreciated that environment 27 may be utilized in applications other than test preparation, and furthermore that environment 27 may interact with viewers other than via web pages served by a web server. Environment 27 may be implemented, for example, within an application server environment, or in other manners recognized by those of ordinary skill in the art. In addition, the electronic content, annotation data, personal preferences, etc. stored in database 28 may alternatively be stored in separate databases. The invention is therefore not limited to the particular implementation described herein.

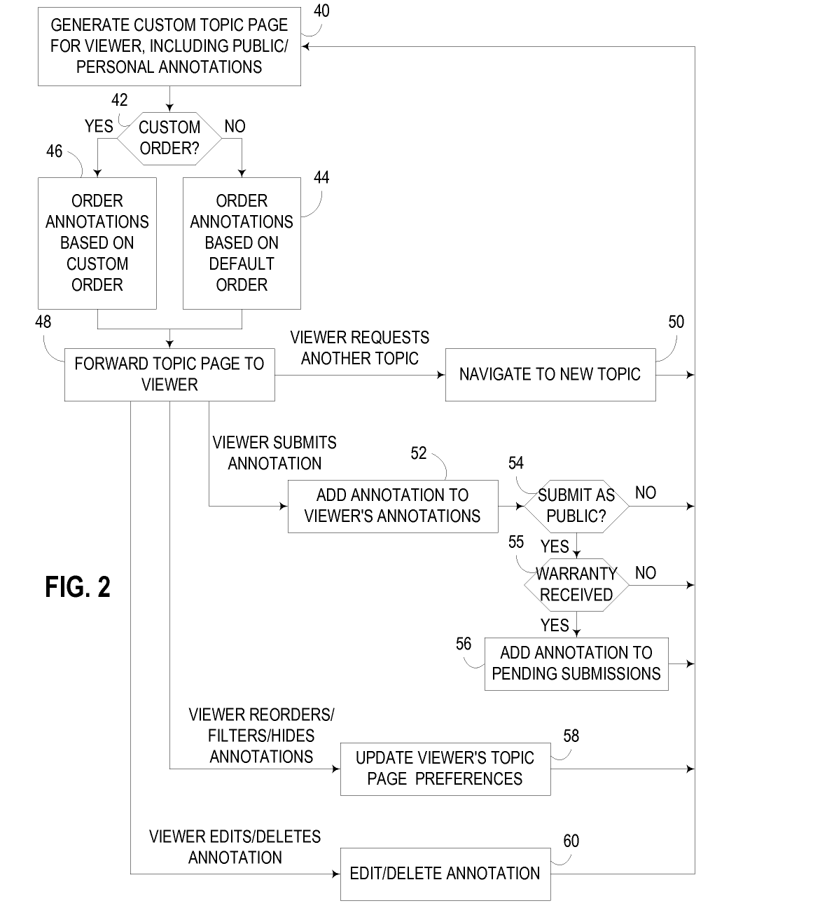

The interface between a viewer and environment 27 is illustrated in greater detail in connection with FIG. 2. As noted above, in the illustrated embodiment, the electronic content is indexed into topics representing portions of the electronic content. Therefore, as shown in block 40, whenever a viewer is interacting with environment 27, a topic page is initially generated for that viewer to present one of the topics in the electronic content. Typically, this page will be custom generated for a particular viewer, and include any personal annotations created by the viewer, along with any other public annotations approved for publication by an editor, typically, but not necessarily, in separate personal and public annotation sections of the page so the viewer can distinguish between their own personal annotations and those created by other viewers.

In addition, each topic page may incorporate any preferences selected by the viewer regarding the display of annotations, e.g., regarding annotation ordering, showing or hiding certain annotations, filtering annotations by group, etc. As shown in block 42, for example, it may be desirable to determine whether a custom ordering of public annotations has been created by the viewer. If not, a default ordering is used to order the public annotations in block 44. However, if a custom order has been selected, that custom ordering is used to order the public annotations in block 46. Thereafter, the topic page is forwarded to the viewer in block 48.

Next, as represented by blocks 50, 52, 58 and 60, a viewer may perform a number of different actions with respect to the currently displayed topic page. It will be appreciated that the actions described in connection with these blocks are by no means exclusive, and a number of additional actions may be undertaken with respect to a currently displayed topic page.

One such action that may be undertaken is the selection of another topic. In response to such a request, the viewer may be navigated to the newly selected topic as shown in block 50, resulting in a custom topic page for the new topic being generated for the viewer in block 40.

Another such action that may be undertaken is the submission of a new annotation. As a result of such a request, the new annotation is typically added to the viewer's personal annotations as shown in block 52. Then, it is determined in block 54 whether the annotation is to be submitted as a potential public annotation, i.e., an annotation that requires review by a third party reviewer.

It will be appreciated that the determination of whether an annotation is to be submitted as a public annotation may vary in different embodiments. In some embodiments, a viewer may be required to specifically submit, or request consideration of, an annotation for publication. In other embodiments, a viewer may be required to specifically mark an annotation as private to inhibit submission of the annotation as a public annotation. In still other embodiments, separate steps may be required to create a personal annotation and then submit the annotation for publication. In yet other embodiments, a viewer may not be required or even permitted to designate a submission as private or public. For example, it may be desirable to permit an annotation to be considered for publication irrespective of whether a viewer has designated the annotation to be a private/personal annotation or a public annotation. In some instances, the viewer may not even be aware that the annotation will be reviewed or used to generate a public annotation. By submitting a personal annotation to the system, the viewer may be considered to have consented to the use of information from that annotation in generating a public annotation.

Returning to block 54, if the annotation is not submitted as a potential public annotation, a new custom topic page is generated for the viewer in block 40, now incorporating the newly added annotation. Otherwise, if the annotation is submitted as a potential public annotation, a determination is then made whether the viewer has warranted the content of the annotation in block 55.

It may be desirable to warrant the content of the annotation, for example, to obtain a confirmation from the viewer that no copyrighted material has been incorporated into the annotation. As an alternative, a warranty may be required to confirm that the content of an annotation represents the viewer's original work product. Such confirmations may also be requested for personal annotations in some environments, while in other embodiments, a confirmation may be made at a different point in time, e.g., when a user initially logs in or registers with the environment, or after the annotation has been reviewed but prior to actually making the annotation public.

Thus, returning to block 55, if a suitable confirmation has been received from the viewer, the annotation is added to a list or queue of pending submissions as shown in block 56. Otherwise, the annotation is not added to the list or queue. However, the annotation typically will remain privately viewable to the viewer. In some instances, the viewer may be reprompted to confirm and/or offered the ability to edit and resubmit the annotation if no confirmation has been received.

Returning to block 48, another action that may be undertaken by a viewer is reordering, hiding, filtering, or otherwise manipulating the annotations displayed on a topic page. In response to such an action, the viewer's preferences for the current topic page are updated in the database in block 58, and the topic page is then regenerated in block 40 to reflect the result of the action taken by the viewer.

Reordering annotations may be supported for public and/or private annotations, and may include actions such as “move to top”, “move to bottom”, “move up”, “move down”, as well as actions such as sorting by a criterion or dragging and dropping annotations to specific points in a list. As will become apparent below, the reordering of annotations may also be tracked and used to generate a default ordering for the annotations associated with a particular topic.

Hiding/showing annotations may be supported for public and/or private annotations, and may enable a viewer to selectively hide annotations that he or she does not wish to view. Individual annotations may be selectively hidden, or annotations may be hidden based upon a criterion, e.g., annotations created by a particular viewer, annotations older than a certain date, etc. In addition, annotations may be organized under folders in some embodiments, with such folders selectively expanded or collapsed to effectively show or hide annotations organized within such folders.

Filtering annotations may also be supported to enable viewers to view only public annotations that match a particular criterion. For example, it may be desirable to categorize or profile certain viewers and enable only the annotations created by certain types of viewers to be displayed. As such, a viewer of USMLE test preparation materials may be able to choose to see only the annotations generated by international medical students, US medical students, medical students from a particular country, state, city or medical school, male or female medical students, medical students ranked above a particular class rank, etc. Such profiles may also be used to sort annotations on behalf of a viewer in some embodiments. As such, groups of annotations associated with groups of viewers sharing a common characteristic may be selectively displayed to individual viewers. It will also be appreciated that hiding/showing annotations or filtering annotations by individual viewers may be tracked in a similar manner to ordering of annotations, with the tracked information used to select default presentation formats for annotations displayed to other viewers.

Another action that may be undertaken by a user is to edit or delete a personal annotation, as shown in block 60. Based upon such an action, the record of the annotation is edited or deleted in the database, and the custom topic page is regenerated in block 40. It will be appreciated that a personal annotation may be precluded from being edited or deleted in some embodiments if the personal annotation has already been reviewed and made public. In other embodiments, editing or deleting a personal annotation after publication may be permitted, but the modification to the personal version of the annotation will typically have no effect on the public version of the annotation.

Other actions that may be undertaken by a viewer in connection with viewing electronic content and associated annotations, as will be appreciated by one of ordinary skill in the art having the benefit of the instant disclosure.

FIG. 3 next illustrates the interface between an editor and environment 27. In particular, as shown in block 70, a list or queue of pending (unreviewed) annotation submissions is prioritized using a ranking algorithm to effectively schedule the review of the annotations. In the illustrated embodiment, for example, the ranking algorithm may be based at least in part upon ratings assigned to individual submitting viewers based upon tracking prior submissions by such viewers. The ratings may be objective in nature, e.g., based upon total number of submissions, total number of accepted submissions, percentage of accepted submissions and/or may be subjective in nature, e.g., based upon a ranking or rating of the viewer by the editors who have reviewed the viewer's prior submissions and/or by other viewers. In addition, the ratings may be based upon feedback directed to individual public annotations, e.g., ratings applied by readers of the public annotations and/or comments submitted by such readers.

Once the list of unreviewed annotations has been prioritized, an annotation is selected from the list and forwarded to an editor in block 72. The forwarding of an annotation to an editor may occur in response to a specific request by the editor, or the annotation may be assigned to an editor's personal list or queue and await action by the editor at a later point in time. Multiple editors may be used to review annotations, and annotations may be routed to particular editors based upon random selection, based upon round-robin selection, based upon backlog, or based upon a particular criterion (e.g., where certain editors have expertise with only a portion of the electronic content).

Next, as shown in block 74, the annotation is reviewed by the editor, e.g., for a qualitative and/or editorial review. Based upon this review, the editor can perform a number of actions. For example, as shown in block 76, the editor may simply reject the annotation, whereby the annotation is not accepted as a public annotation. The editor's review of the annotation is then complete. In some embodiments, the submitting viewer may also be notified of the rejection.

In addition, as shown in block 78, the annotation may be accepted by the editor in its current form and published (i.e., made public). Alternatively, if the editor wishes to edit the annotation prior to accepting the annotation for publication, he or she may be permitted to do so, as shown in block 80, such that the annotation is accepted with revisions. The revisions may be applied solely to the public version of the annotation, although in some embodiments the revisions may also be applied to the private version of the annotation as well. Alternatively, in some embodiments it may be desirable to permit a viewer to “upgrade” his or her private version to match the revised public version of the annotation. In some embodiments, for example, acceptance of an annotation for publication may result in the creation of a separate, public annotation in database 28 that includes the original or modified content of the submitted personal annotation.

If the annotation has been accepted, the annotation is added to the list of public annotations for the relevant topic as shown in block 82, which has the effect of selectively enabling the display of the annotation along with the associated electronic content to other viewers of the electronic content. The submitting viewer's rating is then updated in block 84, e.g., using an objective standard such as incrementing the number of accepted annotations and/or using a subjective standard such as soliciting a rating for the viewer or the particular annotation from the editor.

Next, in block 86 the default annotation ordering for the topic associated with the new public annotation is updated. The update may be based at least in part upon the rating of the viewer that submitted the annotation, the rating of the annotation itself, ordering by the editor, and/or the custom orderings of public annotations selected by other viewers of the topic (e.g., as discussed above in connection with blocks 42-46 and 58 of FIG. 2). Once the default ordering has been updated, block 70 once again prioritizes the unreviewed annotation submissions in the manner discussed above.

Editor/review operations other than those described in connection with FIG. 3 may also be supported, as will be appreciated by one of ordinary skill in the art having the benefit of the instant disclosure. For example, it may be desirable to permit the editor to access all of the personal and/or public annotations submitted by a particular viewer. It may also be desirable to permit an editor to order public annotations, e.g., to place a new annotation in a specific position in an existing ordering after the annotation has been approved for publication. It may also be desirable to permit an editor to create a new public annotation, whether or not based upon an existing personal annotation.

The submission of annotations by a viewer may be tracked for the purpose of incentivizing viewers to submit annotations and to improve the quality of the annotations being submitted. For example, viewers may be awarded publication credits based upon the number and/or quality of annotations they submit. The publication credits may be based simply on the number of annotations that have been published, or the credits may be based upon other factors such as the quality of the submissions, the number of submissions that have not been accepted, etc.

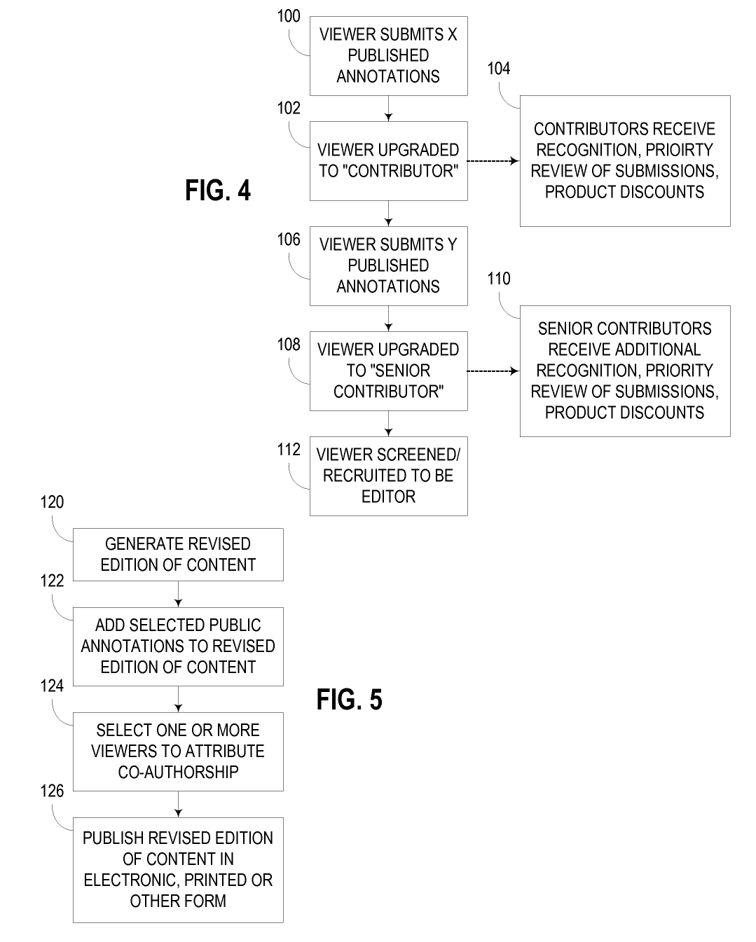

The publication credits may be used in connection with a number of different incentives. For example, as shown in FIG. 4, viewers may be given titles, ratings or ranks after a certain number of accepted submissions. Specifically block 100 illustrates a viewer submitting X published annotations and thereafter being upgraded to a “contributor.” In addition, as shown in block 104, a viewer designated as a “contributor” may receive recognition, e.g., by being designated as such in association with any public annotations displayed to other viewers, or in a specific section of a web site. In addition, a “contributor” viewer may be prioritized for the review of future submissions, e.g., as discussed above in connection with FIG. 3. Furthermore, such a viewer may receive financial compensation, e.g., via product or service discounts, or even via payment for services rendered.

In addition, as shown in blocks 106-108, multiple classifications of viewers may be used, e.g., so that after another milestone of Y accepted submissions is reached by a viewer, the viewer is upgraded to “senior contributor,” and granted additional incentives such as additional recognition, higher priority review, and additional financial compensation, as shown in block 110.

Furthermore, as illustrated in block 112, after enough submissions have been accepted from a viewer, it may be desirable to screen and/or recruit the viewer to be an editor. As such, an additional incentive for a viewer to create submissions is the possibility of being made an editor, and potentially receiving financial compensation in connection with same.

Yet another incentive for a viewer to create submissions is the potential for attribution of authorship. The authorship may be attributed for individual annotations (e.g., by displaying the name or other identification data, such as school, rank, rating, credits, or email address, for the viewer alongside any public annotations), or alternatively, co-authorship may be attributed for a viewer for a subsequent edition or revision of the electronic content. For example, as shown in FIG. 5, it may be desirable, after some point in time, to republish the electronic content. When doing so, a revised edition of the electronic content may be generated as shown in block 120, and in connection with this process, one or more public annotations associated with the prior edition of the electronic content may be incorporated directly into the revised edition (block 122). Thereafter, one or more viewers of the prior edition of the electronic content that contributed a relatively large number of public annotations (e.g., a large number of annotations that were incorporated directly into the revised edition) may be selected for receiving attribution as a co-author of the revised edition, as shown in block 124. Then, once the revised edition is published, as shown in block 126, the authorship of the revised edition may indicate that the viewer is a co-author of the electronic content.

The publication of the revised edition may be in electronic form, or alternatively, may be in printed or other form. In addition, whether or not a viewer is attributed with co-authorship or even designated as an editor may be programmatically determined in some embodiments according to an objective standard, although in other embodiments the decision of whether to make a viewer a co-author or editor may instead be subjective in nature.

Other manners of incentivizing viewers to submit annotations for publication will be apparent to one of ordinary skill in the art having the benefit of the instant disclosure.

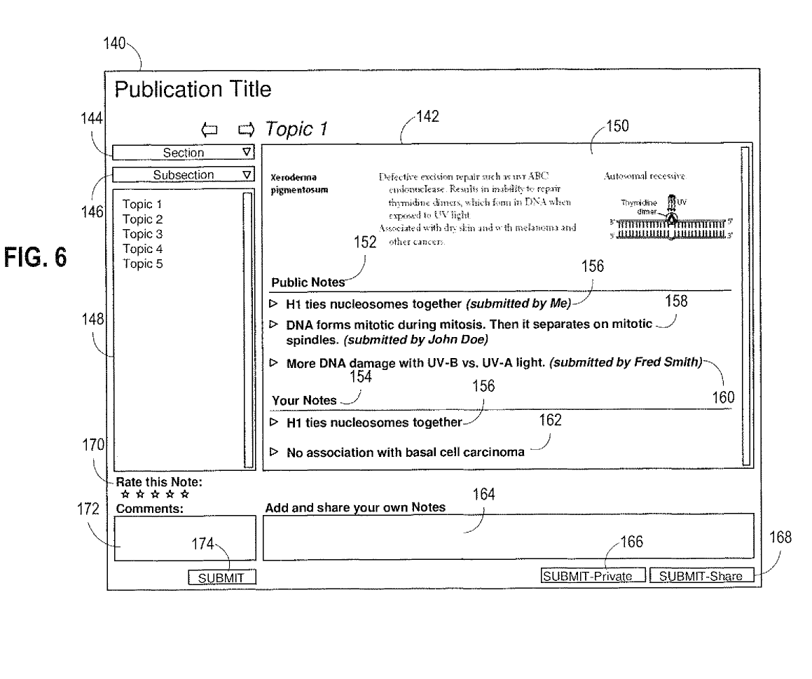

While a multitude of other display representations may be used to present annotations alongside electronic content, FIG. 6 illustrates one exemplary display 140 that may be presented to a viewer, e.g., within a Flash-enabled Internet browser. Display 140 includes a topic frame 142 in which a single topic among a plurality of topics is displayed to a viewer. Topics may be organized into sections and subsections, which are respectively selected via controls 144, 146, and a list of topics within a currently selected section and subsection may be displayed in an index or table of contents frame 148.

Within topic frame 142 is a topic section 150 within which a portion of the electronic content, specifically, the electronic content pertaining to the current topic, is displayed. In addition, public and personal annotation sections 152, 154 are displayed within topic frame 142, for respectively displaying associated public and personal annotations, e.g., annotations 156, 158, 160 and 162.

Display 140 also includes an input frame 164 within which a viewer may input a new annotation. The input frame may support text, graphics, video, audio, etc., and may allow for direct entry by a user and/or cutting and pasting of existing content into the frame. Submission of a new annotation is requested via either a private submission control 166 or a public/share submission control 168.

It may also be desirable to permit a viewer to rate annotations submitted by other viewers. For example, a viewer may be permitted to select a public annotation and rate that annotation via a control 170 and/or add a comment regarding the annotation via an input box 172 and submit control 174. The submission of comments may be used, for example, to alert an editor or administrator of a problem with a particular annotation, or to suggest revisions to an annotation.

Returning to annotations 156, 158, 160, and 162, annotation 156 illustrates a personal annotation that has been approved for publication. As a result, this annotation is displayed in both the public and personal annotation sections 152, 154, and is designated in public annotation section 152 as being authored by the viewer. In other embodiments, once a personal and public annotation may only be displayed in one section 152, 154.

Annotations 158 and 160 illustrate public annotations that have been submitted by other viewers (John Doe for annotation 158 and Fred Smith for annotation 160). Annotation 162 illustrates a personal and still private annotation that has been created by the viewer, but which has not yet been reviewed and approved, or for which the viewer has never sought publication.

It will be appreciated that the viewer may be able to perform a number of actions on annotations 156, 158, 160 and 162, e.g., reordering the annotations, editing the annotations, deleting the annotations, hiding or showing the annotations, filtering the annotations, etc. by manipulating the annotations via one or more controls. For example, it may be desirable to right-click on an annotation to pull up a context sensitive menu or a separate dialog box to provide a list of suitable actions that may be performed on an annotation. A viewer may also be able to contact another viewer, access other annotations by another viewer, or perform other suitable actions via interaction with the identification data for the other viewer appended to each public annotation.

Other features and controls may be incorporated into display 140, as will be apparent to one of ordinary skill in the art having the benefit of the instant disclosure.

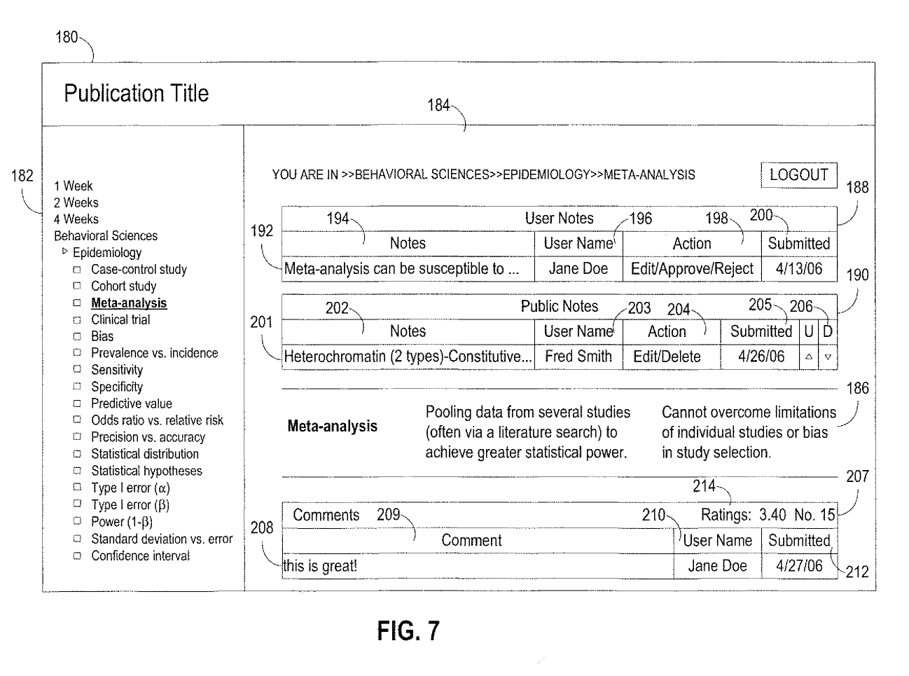

FIG. 7 illustrates an exemplary display 180 that may be presented to an editor or reviewer for the purpose of reviewing submitted annotations. Display 180 includes an index or table of contents frame 182 from which different topics are presented in a hierarchical fashion. A main frame 184 includes a table of annotations associated with the currently selected topic from frame 182.

All or a portion of the content associated with the topic may be displayed for the editor's convenience as shown at 186. In addition, a pending submission table 188 and an accepted submission table 190 are displayed within main frame 184.

Pending submission table 188 includes one or more entries 192 representing annotations awaiting review. Each entry includes a field 194 for the text of the annotation, along with a user name field 196 for the user name of the submitting viewer, an action field 198 from which various editor actions may be performed, and a submitted field 200 identifying the date the annotation was submitted. The action field 198 may include various actions that an editor may wish to perform on an annotation, e.g., to edit the annotation, approve the annotation, or reject the annotation. Additional actions, such as rating the submitting viewer, may also be supported.

Accepted submission table 190 includes entries 201 for each accepted (i.e., public) annotation, and includes fields 202, 203, 204 and 205 that serve the same purpose as fields 194, 196, 198 and 200 of table 188. In addition, table 190 may also include controls such as controls 206 to permit an editor to control the sort order for public annotations. Different types of actions may be supported for public annotations in some embodiments.

Display 180 also includes a comments table 207, which displays, for a currently selected annotation from either of table 188, 190, any comments associated with the annotation. Each comment is represented by an entry 208 including a comment field 209 that includes the text of the comment, a user name field 210 that includes the user name of the comment creator, and a submitted field 212 that indicates the date of the comment. Table 207 may also include a ratings field 214 that indicates, for a selected annotation, an average rating and/or a number of ratings submitted by viewers for that annotation.

Other features and controls may be incorporated into display 180, as will be apparent to one of ordinary skill in the art having the benefit of the instant disclosure.

Various additional modifications may be made to the illustrated embodiments without departing from the spirit and scope of the invention. Therefore, the invention lies in the claims hereinafter appended.

1. A method of annotating electronic content, the method comprising:
receiving from a first viewer of electronic content an annotation that has been created by the first viewer and that is associated with the electronic content;
generating a display of the electronic content for the first viewer that includes the annotation along with the electronic content; and
based upon a review of the annotation by a party other than the first viewer, selectively enabling display of the annotation along with the electronic content to other viewers of the electronic content.

2. The method of claim 1, wherein the party other than the first viewer comprises an editor, the method further comprising forwarding the annotation to the editor to enable the editor to conduct the review.

3. The method of claim 2, wherein the review of the annotation includes a qualitative review of the annotation to determine a suitability of the annotation for display along with the electronic content.

4. The method of claim 2, wherein the review of the annotation includes an editorial review of the annotation.

5. The method of claim 2, further comprising editing the annotation in response to input from the editor.

6. The method of claim 2, wherein forwarding the annotation to the editor is performed in response to input from the first viewer requesting consideration of the annotation for publication.

7. The method of claim 6, further comprising requiring a confirmation from the first viewer that the annotation does not contain copyrighted material prior to selectively enabling display of the annotation to other viewers.

8. The method of claim 7, further comprising maintaining the annotation as a personal annotation if no confirmation is received from the first viewer.

9. The method of claim 2, wherein forwarding the annotation to the editor is performed after the annotation is received from the first viewer but without specific input from the first viewer requesting consideration of the annotation for publication.

10. The method of claim 2, further comprising:
receiving annotations from a plurality of viewers of the electronic content;
rating viewers based upon prior annotations submitted by such viewers; and
scheduling the review of the annotations by at least one editor based upon the rating of at least one viewer.

11. The method of claim 2, wherein forwarding the annotation to the editor is performed irrespective of whether the first viewer has designated the annotation to be a personal annotation.

12. The method of claim 1, further comprising maintaining the annotation as a personal annotation after the review if display of the annotation to other viewers is not selectively enabled based upon the review.

13. The method of claim 1, further comprising, after display of the annotation to other viewers is selectively enabled based upon the review, modifying a private version of the annotation in response to input from the first viewer without modifying a public version of the annotation that is displayed to other viewers.

14. The method of claim 1, wherein the annotation is associated with a predetermined portion of the electronic content, and wherein the generated display includes the annotation along with the predetermined portion of the electronic content.

15. The method of claim 14, wherein the generated display includes the predetermined portion of the electronic content and a personal annotation section including the annotation.

16. The method of claim 15, wherein the generated display comprises a web page including the portion of the electronic content and the personal annotation section.

17. The method of claim 15, wherein the generated display includes at least one public annotation disposed in a public annotation section of the display, wherein the public annotation is received from a second viewer and reviewed by a party other than the first or second viewers.

18. The method of claim 17, wherein the generated display includes a plurality of public annotations in the public annotation section, the method further comprising ordering the plurality of public annotations in the public annotation section of the display generated for the first viewer based upon input from the first viewer.

19. The method of claim 18, further comprising:
tracking selected orderings of the public annotations by a plurality of viewers;
generating a default ordering of the plurality of public annotations based at least in part upon the tracked selected orderings; and
generating a display of the portion of the electronic content for a second viewer with at least a subset of the plurality of public annotations ordered in a public annotation section according to the default ordering.

20. The method of claim 17, further comprising hiding the public annotation for the first viewer in response to input from the first viewer such that the public annotation is omitted from the generated display for the first viewer.

21. The method of claim 1, wherein the electronic content comprises educational material.

22. The method of claim 21, wherein the electronic content comprises test preparation material.

23. The method of claim 1, further comprising tracking annotations submitted by the first viewer for which display to other viewers of the electronic content has been selectively enabled based upon a review.

24. The method of claim 23, wherein tracking the annotations submitted by the first viewer includes determining a publication credit associated with the first viewer.

25. The method of claim 23, further comprising compensating the first viewer based upon the tracked annotations.

26. The method of claim 23, further comprising attributing authorship to the first viewer based upon the tracked annotations.

27. The method of claim 26, wherein attributing authorship to the first viewer includes attributing co-authorship for the electronic content to the first viewer in a subsequent edition of the electronic content.

28. The method of claim 26, wherein attributing authorship to the first viewer includes attributing co-authorship for the electronic content to the first viewer in a print edition of the electronic content.

29. The method of claim 26, wherein attributing authorship to the first viewer includes displaying identification data associated with the first viewer in association with the annotation in the generated display.

30. The method of claim 1, further comprising:
associating the annotation with a group of annotations associated with a plurality of viewers having a common characteristic; and
generating a display for another viewer that displays the group of annotations associated with the viewers having the common characteristic in response to input from the other viewer to display annotations associated with the users having the common characteristic.

31.-32. (canceled)

33. A method of displaying electronic content, the method comprising:
for each of a plurality of viewers of electronic content, generating a display associated with such viewer that includes a plurality of annotations related to the electronic content;
generating a default ordering for the plurality of annotations based at least in part upon how at least a subset of the plurality of viewers reorder the annotations in their associated displays; and
generating a display associated with an additional viewer that includes the plurality of annotations ordered according to the generated default ordering.

34. The method of claim 33, further comprising reordering the annotations in the display associated with a first viewer among the plurality of viewers based upon input from the first viewer, wherein generating the default ordering includes determining the order of the plurality of annotations in the display associated with the first viewer after reordering by the first viewer.

35. The method of claim 33, further comprising reordering the annotations in the display associated with the additional viewer based upon input from the additional viewer.

36. The method of claim 33, wherein the plurality of annotations are associated with a predetermined portion of the electronic content, and wherein the display associated with each viewer includes the predetermined portion of the electronic content and a public annotation section including the plurality of annotations.

37. The method of claim 36, wherein the display associated with at least one of the plurality of viewers further includes a personal annotation section including at least one annotation generated by the at least one of the plurality of viewers.

38. The method of claim 33, wherein generating the default ordering is additional based at least in part upon a rating associated with a creator of at least one annotation.

39.-40. (canceled)

41. A method of reviewing annotations associated with electronic content, the method comprising:
receiving a plurality of annotations relating to electronic content submitted by a plurality of viewers of the electronic content;
rating viewers based upon prior annotations submitted by such viewers; and
scheduling reviews of the annotations by at least one editor based upon the rating of at least one viewer.

42. The method of claim 41, further comprising selectively enabling display of at least one annotation submitted by a viewer along with the electronic content to other viewers of the electronic content based upon a review of such annotation by the at least one editor.

43.-44. (canceled)
